(19) United States
(12) Patent Application Publication
(10) Pub. No.: US 2010/0251251 A1
(43) Pub. Date: Sep. 30, 2010

(54) APPARATUS AND METHOD FOR CPU LOAD CONTROL IN MULTITASKING ENVIRONMENT

(75) Inventor: Yoong-Hee Lee, Gyeonggi-do (KR)

Correspondence Address: CHA & REITER, LLC, 210 ROUTE 4 EAST STE 103, PARAMUS, NJ, 07652, US

(73) Assignee: Samsung Electronics Co., Ltd., Gyeonggi-Do (KR)

(21) Appl. No.: 12/732,466

(22) Filed: Mar. 26, 2010

(30) Foreign Application Priority Data
Mar. 26, 2009 (KR) 10-2009-0025689

(51) Int. Cl. G06F 9/50; G06F 9/46

(52) U.S. Cl. 718/103; 718/105; 718/104

(57) ABSTRACT

An apparatus and a method for a Central Processing Unit (CPU) load control in a portable terminal capable of multitasking are provided. The method includes determining, by an application, an expected CPU load from a load table, requesting, by the application, a determination whether the expected CPU load is acceptable by providing the expected CPU load to a CPU load manager, providing, by the CPU load manager, a response including a result indicating whether the expected CPU load is acceptable or not to the application and executing, by the CPU, the application based on the result.

### CLAIM OF PRIORITY

This application claims the benefit of the earlier filing date, under 35 U.S.C. §119(a), of that Korean patent application filed in the Korean Intellectual Property Office on Mar. 26, 2009 and assigned Serial No. 10-2009-0025689, the entire disclosure of which is hereby incorporated by reference.

### BACKGROUND OF THE INVENTION

1. Field of the Invention

The present invention relates to a Central Processing Unit (CPU) load control and more particular to an apparatus and a method for CPU load control in the case of multitasking CPU overload

2. Description of the Related Art

The loading of a Central Processing Unit (CPU) depends on the demands placed on the CPU by applications which request execution in a multitasking environment. That is, when applications are executing, the applications request the resources from the CPU without consideration of a CPU overload. This CPU load is particularly important in a multitasking environment of a portable terminal that supports multitasking.

In this case, the CPU adjusts a clock of the CPU in order to control the CPU load according to a requested CPU load of each of the corresponding applications. For example, when the CPU is operating with at a clock rate of 200 MHz and when the media player, for example, is executing and when a requested CPU load from the media player is increasing, the CPU raises the clock rate up to 400 MHz.

In this scheme, when the requested CPU load from some applications requires the CPU clock to exceed a maximum operating clock rate, a response time for a corresponding request is increased. Thus, a corresponding application may not operate within a desired time limit.

Thus, when the CPU load reaches substantially near 100%, a response time for the corresponding application is increased and the corresponding application may not operate within a desired time limit.

For example, assuming that the CPU clock is configured to maximum value and the CPU load is 50%. When the media player requests 60% of the CPU load at the maximum clock, a delay occurs due to the request exceeding an available CPU load.

Accordingly, a need exists for an apparatus and a method for CPU load control in multitasking environment.

### SUMMARY OF THE INVENTION

Accordingly, an aspect of the present invention is to provide an apparatus and a method for a Central Processing Unit (CPU) load control in a multitasking environment.

In accordance with an aspect of the present invention, an apparatus comprising: a CPU load manager for: receiving an expected CPU load associated with an application; determining whether the expected CPU load is acceptable; providing a response including a result indicating whether the expected CPU load is acceptable or not; a CPU for executing the application based on the result; and, a storage unit for storing application priorities, an application CPU load table, a CPU clock and a CPU load.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 illustrates a block diagram for controlling a CPU load according to an exemplary embodiment of the present invention;

FIG. 2 illustrates a flowchart for controlling a CPU load according to an exemplary embodiment of the present invention;

FIG. 3 illustrates a flowchart of a CPU load manager operation according to an exemplary embodiment of the present invention; and,

FIG. 4 illustrates a block diagram for a portable terminal according to an exemplary embodiment of the present invention;

### DETAILED DESCRIPTION OF THE INVENTION

Exemplary embodiments of the present invention will be described below with reference to the accompanying drawings. In the following description, well-known functions or constructions are not described in detail since they would obscure the invention in unnecessary detail.

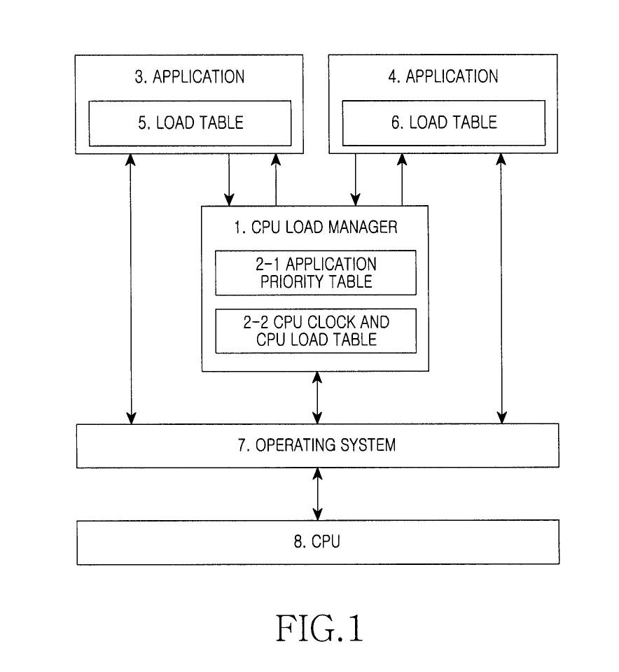

FIG. 1 illustrates a block diagram for controlling a CPU load according to an exemplary embodiment of the present invention.

Referring FIG. 1, a block diagram for controlling a CPU load comprises a CPU load manager 1, which includes an application priority table 2-1, a CPU clock (not shown) and a CPU load table 2-2, applications 3, 4 including load tables 5, 6, respectively, an operating system 7 and a CPU 8.

The CPU load manager 1 determines an operating condition of a CPU clock and a CPU load per a CPU load determining period and stores to the operating condition of the CPU clock and CPU load in the CPU load table 2-2.

The CPU load manager 1 determines whether the applications 3, 4, which are to be executed, based on a maximum operating condition of the CPU clock of the CPU 8 and a maximum load of the CPU 8 and the application priority entries in application priority table 2-1 associated with applications 3 and 4.

The CPU load manager 1 determines whether an application has higher priority than a currently executing application and the CPU load manager 1 determines a response to the application according to the CPU clock and a CPU load table 2-2 and the application priority table 2-1 when the application has higher priority than the currently executing application. When the priority of the application is higher than the currently executing application, the CPU load manager 1 requests the currently executing application with lower priorities than the application to lower its contribution on the CPU load.

The CPU load manager 1 manages applications such that the CPU 8 operates under the maximum operating condition of the clock of the CPU 8 and a maximum load of the CPU 8.

Before the applications 3, 4 request CPU loads through the operating system 7, the applications 3, 4 determine an expected CPU load for each of the applications 3, 4 from the load tables 5, 6 respectively. Hereafter, the applications 3, 4 request the CPU load manager 1 determine whether the expected CPU loads are acceptable and the applications 3, 4 are executed according to responses from the CPU load manager 1.

The operating system 7 receives the requests, such as interrupts from the applications 3, 4, and transfers the requests to the CPU 8 and the operating system 7 transfers a result of the request from the CPU 8 to corresponding applications 3, 4. The CPU 8 processes the requests from the applications 3, 4 through the operating system 7. The requests between the applications 3, 4 and the CPU 8 through the operating system 7 are for corresponding application operation such as system calls or the interrupts

When a media player requests execution, an expected CPU load associated with the media player is provided to the CPU load manager. The CPU load manager 1 determines the effect of the request on a current CPU clock and a CPU load per a CPU load determining period and stores the CPU clock and the CPU load in CPU load table 2-2. The CPU load manager 1 then compares the expected CPU load from the media player with the current CPU load.

The CPU load manager 1 determines whether the expected CPU load is greater than either the maximum clock or the maximum CPU load. When the expected CPU load is neither greater than the maximum clock nor the maximum CPU load, the CPU load manager 1 determines an available CPU load and transfers the available CPU load to the media player.

The media player plays media according to the available CPU load from the CPU load manager 1. That is, the media player determines a minimum Frame per Second (FPS) according to the available CPU load and the media player plays the media according to the determined FPS.

The media player determines the available CPU load as a determined CPU load and updates the associated media player load table by storing the determined CPU load to the media player load table.

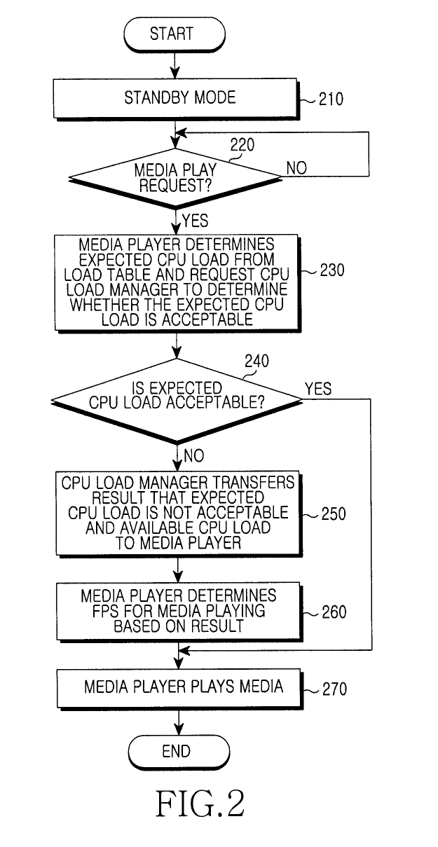

FIG. 2 illustrates a flowchart for controlling a CPU load according to an exemplary embodiment of the present invention.

Referring to FIG. 2, a portable terminal is in standby mode in step 210. When an event for media playing, for example, occurs from a user or a media player in step 220, a media player determines an expected CPU load for media playing from a load table and provides a request to the CPU load manager to determine whether the expected CPU load is acceptable in step 230.

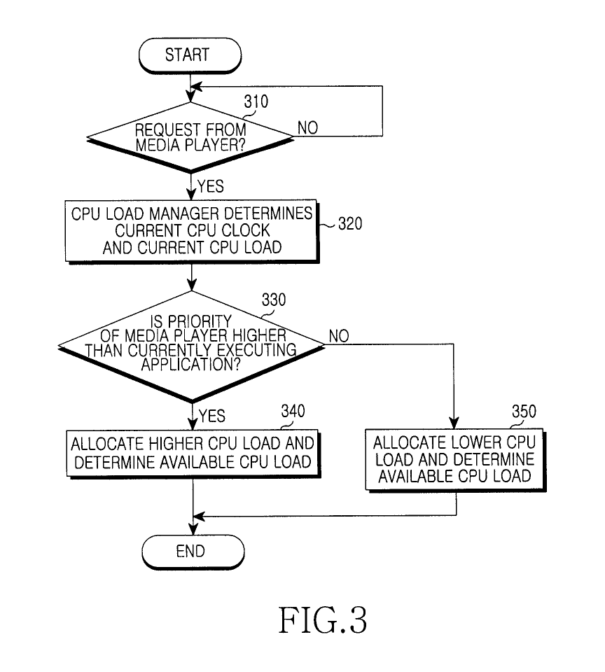

The CPU load manager then determines whether the expected CPU load is acceptable in view of a current CPU load in step 240. The determination step will be explained in FIG. 3.

When the expected CPU load is acceptable, the CPU load manager provides a result that the expected CPU load is acceptable and a current CPU load to the media player and the media player plays media in step 270. In this step, the media player plays media at a default FPS. The default FPS may be determined by simulations, developers, operators or any other means, without undue experimentation by those having skill and knowledge in the art.

When the expected CPU load is not acceptable, the CPU load manager transfers a result that the expected CPU load is not acceptable and an available CPU load to the media player in step 250.

The media player determines a FPS for media playing based on the result and the available CPU load in step 260 and the media player plays media in step 270.

The CPU load manager may request the currently executing application, other than the media player, to lower its corresponding CPU load.

FIG. 3 illustrates a flowchart of a CPU load manager operation according to an exemplary embodiment of the present invention.

Referring to FIG. 3, when a CPU load manager receives a request to determine whether an expected CPU load from a media player is acceptable in step 310, the CPU load manager determines a current CPU clock and a current CPU load in step 320.

The CPU load manager next determines whether a priority of the media player is higher than that of a currently executing application in step 330. In this case, the CPU load manager refers to an application priority table 2-1 (FIG. 1). The application priority table stores a priority of a corresponding application.

When the priority of the media player is higher than the currently executing application, the CPU load manager allocates more CPU load to the media player than the currently executing application. That is the CPU load manager may request that the currently executing application re-allocate its CPU load to a lower value. The CPU load manager then determines whether the expected CPU load, in addition to the CPU load of the currently executing application (i.e., current CPU load), is acceptable according to the allocation and a maximum CPU load. When the expected CPU load is acceptable, the CPU load manager provides a result that the expected CPU load is acceptable and a current CPU load to the media player. However, when the expected CPU load, in addition to the CPU load of the currently executing application(s), is not acceptable, the CPU load manager determines an available CPU load according to the allocation and a maximum CPU load and the CPU load manager transfers a result that the expected CPU load is not acceptable and the available CPU load to the media player in step 340. Herein, the available CPU load is determined as an allocated CPU load for the media player.

When the priority of the media player is lower than the currently executing application, the CPU load manager allocates less CPU load to the media player than the currently executing application(s). That is the CPU load manager may request that the media player application re-allocate its expected CPU load to a lower value. Then CPU load manager determines whether the expected CPU load, in addition to the CPU load of the currently executing application(s), is acceptable according to the allocation and a maximum CPU load. When the expected CPU load is acceptable, the CPU load manager provides a result that the expected CPU load is acceptable and a current CPU load to media player. However, when the expected CPU load, in addition to the CPU load of the currently executing application, is not acceptable, the CPU load manager determines an available CPU load according to the allocation and a maximum CPU load. The CPU load manager transfers a result that the expected CPU load is not acceptable and the available CPU load to the media player in step 350.

An amount for more and less of CPU load may be determined by simulations, developers, operators or any other means, without undue experimentation by those having skill and knowledge in the art.

When there is no currently executing application other than the media player and when the expected CPU load is acceptable, the CPU load manager may allocate the expected CPU load to the media player.

When a sum of the expected CPU load and the current CPU loads, which is a sum of CPU loads of already executing applications, is less than the maximum CPU load, the CPU load manager may allocate the expected CPU load to the media player.

When the media player is of higher priority than currently executing applications, the expected CPU load may stay the same and the CPU loads of other applications may be reduced.

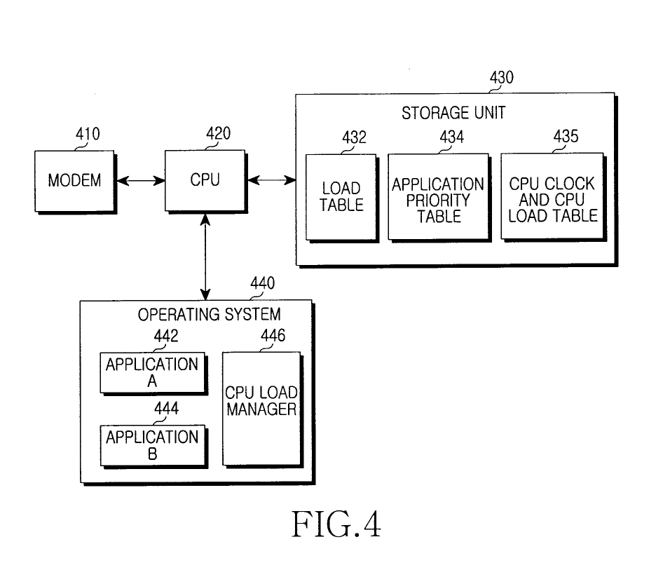

FIG. 4 illustrates a block diagram of a portable terminal according to an exemplary embodiment of the present invention.

Referring to FIG. 4, the portable terminal comprises a communication modem 410, a CPU 420, a storage unit 430 and an operating system 440. Application A 442, Application B 444 and a CPU load manager 446 may be executing in the operating system 440.

The communication modem 410 is a module for performing communication with another node (not shown), and includes a radio processor and a base-band processor (not shown). The radio processor converts a signal received through an antenna into a base-band signal and provides the base-band signal to the base-band processor. Further, the radio processor converts the base-band signal received from the base-band processor into a radio signal so that the received signal can be transmitted through an actual wireless path, and then transmits the radio signal through the antenna.

The CPU 420 controls an overall operation of the portable terminal, as previously discussed. The operating system 440 is one process executed in the CPU 420. When the operating system 440 is executed in the CPU 420, the operating system 440 may control the portable terminal and other functional modules (e.g., voice calling service, text service, display functions, etc.).

The storage unit 430 performs a function of storing a program for controlling the overall operation of the portable terminal and for storing temporary data generated in the process of executing the program. The storage unit 430 includes a load table 432, an application priority table 434, a CPU clock and a CPU load table 435.

The CPU load manager 446 determines whether an expected CPU load received from a specific application is acceptable in view of a current CPU load. When the expected CPU load, in addition to the CPU load of other currently executing applications, is acceptable, the CPU load manager 446 provides a result that the expected CPU load is acceptable and a current CPU load to the specific application. When the expected CPU load is not acceptable, the CPU load manager 446 provides a result that the expected CPU load is not acceptable and the available CPU load to the specific application.

When the CPU load manager 446 receives from the specific application a request to determine whether the expected CPU load is acceptable, the CPU load manager 446 determines a current CPU clock rate and a current CPU load.

The CPU load manager 446 determines whether a priority of the specific application is higher than a currently executing application. In this case, the CPU load manager 446 refers to the application priority table 434. The application priority table 434 stores a priority of a corresponding application.

When the priority of the specific application is higher than the currently executing application, the CPU load manager 446 tries to allocate more CPU load to the specific application than the currently executing application and the CPU load manager 446 determines whether the expected CPU load, in addition to the CPU load of other currently executing applications, is acceptable according to the allocation and a maximum CPU load. When the expected CPU load is acceptable, the CPU load manager 446 provides a result that the expected CPU load is acceptable and a current CPU load to the specific application. However, when the expected CPU load is not acceptable, the CPU load manager 446 determines an available CPU load according to the allocation and a maximum CPU load and the CPU load manager 446 transfers a result that the expected CPU load is not acceptable and the available CPU load to the specific application.

When the priority of the specific application is lower than the currently executing application, the CPU load manager 446 tries to allocate less CPU load to the specific application than the currently executing application(s) and the CPU load manager 446 determines whether the expected CPU load, in addition to the CPU load of other currently executing applications, is acceptable according to the allocation and a maximum CPU load. When the expected CPU load is acceptable, the CPU load manager 446 provides a result that the expected CPU load is acceptable and a current CPU load to the specific application. However, when the expected CPU load is not acceptable, the CPU load manager 446 determines an available CPU load according to the allocation and a maximum CPU load and the CPU load manager 446 transfers a result that the expected CPU load is not acceptable and the available CPU load to the specific application.

When there is no currently executing application other than the specific application and when the expected CPU load is acceptable, the CPU load manager 446 may allocate the expected CPU load to the specific application.

Herein, the CPU load manager 446 may request the currently executing applications with lower priorities than the requesting application to lower their CPU load.

The CPU 420 may serve as the operating system 440. Herein, they are separately illustrated to distinguish their functions. In an alternate embodiment, the CPU 420 may process all or part of the functions of the operating system 440.

The present invention controls CPU loads using the CPU load manager according to a current CPU load status in a portable terminal which supports multitasking so that the CPU load may be managed so as to prevent a response delay from the CPU and performance degradation.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. As would be recognized by those skilled in the art, when a general purpose computer is loaded with, or accesses, software or code for implementing the processing shown herein, the general purpose computer is transformed into a special purpose computer that may at least perform the processing shown herein.

While the present invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the scope of the invention is defined not by the detailed description of the invention but by the appended claims and their equivalents, and all differences within the scope will be construed as being included in the present invention.

What is claimed is:

1. A method for Central Processing Unit (CPU) load control in a portable terminal which supports multitasking, the method comprising:
determining, by a selected application an expected CPU load from a load table;
requesting by the selected application, a determination whether the expected CPU load is acceptable by providing the expected CPU load to a CPU load manager;
providing to the selected application, a response including a result indicating whether the expected CPU load is acceptable or not, by the CPU load manager; and
executing, by the CPU, the selected application based on the result.

2. The method of claim 1, further comprising:
determining, by the CPU load manager, a CPU load and a CPU clock rate periodically;
determining, by the CPU load manager, a maximum CPU clock rate; and
determining a priority of the selected application.

3. The method of claim 1, further comprising:
storing by the selected application in the load table the expected CPU load.

4. The method of claim 1, wherein the step of providing a response including a result indicating whether the expected CPU load is acceptable or not to the application comprises:
allocating less CPU load to a currently executing application when the selected application has a higher priority;
determining whether the expected CPU load is acceptable according to the allocation and a maximum CPU load; and
providing to the specific application one of: a response indicating the expected CPU load is acceptable and a current CPU load and a response indicating the expected CPU load is not acceptable and an available CPU load.

5. The method of claim 1, wherein the step of providing a response including a result indicating whether the expected CPU load is acceptable or not to the application comprises:
allocating less CPU load than the expected CPU load of the selected application when the selected application has lower priority than a currently executing application;
determining whether the allocated expected CPU load is acceptable according to the allocation and a maximum CPU load; and
providing to the selected application one of: a response indicating the expected CPU load is acceptable and a current CPU load and, a response indicating the expected CPU load is not acceptable and an available CPU load.

6. The method of claim 1, further comprising:
requesting, by the CPU load manager, a currently executing application with a lower priority than the selected application to lower its CPU load.

7. An apparatus for a Central Processing Unit (CPU) load control in a portable terminal capable of multitasking, the apparatus comprising:
a CPU load manager for:
receiving an expected CPU load associated with an application;
determining whether the expected CPU load is acceptable;
providing a response including a result indicating whether the expected CPU load is acceptable or not;
a CPU for executing the application based on the result; and
a storage unit for storing application priorities, an application CPU load table, a CPU clock and a CPU load.

8. The apparatus of claim 7, wherein the CPU load manager:
determines a CPU load and a CPU clock periodically,
determines a maximum CPU clock rate; and
determines a priority of the application.

9. The apparatus of claim 7, wherein the application stores the expected CPU load in the load table.

10. The apparatus of claim 7, wherein providing a response comprises:
determining a priority of the application;
allocating more CPU load than the expected CPU load of the application when the application has a higher priority than a currently executing application;
determining whether the expected CPU load is acceptable according to the allocation and a maximum CPU load; and
providing to the application one of: a response indicating the expected CPU load is acceptable and a current CPU load and a response indicating the expected CPU load is not acceptable and an available CPU load.

11. The apparatus of claim 7, wherein the CPU load manager further comprising:
determining a priority of the application;
allocating less CPU load than the expected CPU load of the application when the application has a lower priority than a currently executing application;
determining whether the expected CPU load is acceptable according to the allocation and a maximum CPU load; and
providing one of: a response indicating the expected CPU load is acceptable and a current CPU load and a response indicating the expected CPU load is not acceptable and an available CPU load.

12. The apparatus of claim 7, wherein the CPU load manager requests a currently executing application with a lower priority than the application to lower a CPU load.

13. An apparatus for controlling the loading a CPU in a multitasking environment; comprising:
a processor in communication with a memory, the memory including code which when accessed by the processor causes the processor to:
obtain an expected CPU load associated with an application;
determine whether the expected CPU load is acceptable;
provide a response indicating whether the expected CPU load is acceptable; and
operate the application in accordance with the expected CPU load.

14. The apparatus of claim 13, wherein the processor stores the expected CPU in a CPU load table.

15. The apparatus of claim 13, wherein the response includes at least one of: an expected CPU load and a current CPU load.

16. The apparatus of claim 13, wherein the code causes the processor to determine the expected CPU load as being acceptable by:
determining whether the expected CPU load is less than a maximum CPU load; and
providing an indication of acceptable when the expected CPU load is less than the maximum CPU load and a current CPU load.

17. The apparatus of claim 13, wherein the code causes the processor to determine the expected CPU load as being acceptable by:
determining a priority of the application;
determining whether the expected CPU load in addition to a current CPU load is less than a maximum CPU load, the current CPU load being the sum of the CPU loads of each of at least one currently executing application;
allocating a lower CPU load to each of the at least one currently executing applications having a lower priority than the priority of the application; and
providing one of: an indication of acceptability when the expected CPU load and the current CPU load is less than the maximum CPU load and an indication of unacceptability when the expected CPU load and the current CPU load is not less than the maximum CPU load.

18. The apparatus of claim 17, wherein the indication of acceptability includes at least the current CPU load.

19. The apparatus of claim 17, wherein the indication of unacceptability includes at least an available CPU load.

20. The apparatus of claim 19, wherein the available CPU load is determined as a difference between the maximum CPU load and the current CPU load.
